(19) United States
(12) Patent Application Publication
(10) Pub. No.: US 2006/0051060 A1
(43) Pub. Date: Mar. 9, 2006

(54) Method and system for digitally recording broadcast content

(76) Inventors: Henry Dorovanessian, San Diego, CA (US); Hajime Inoue, San Diego, CA (US); Hiroshi Yasunishi, San Diego, CA (US); Yoshiaki Matsumura, San Diego, CA (US)

Correspondence Address: WAGNER, MURABITO & HAO LLP, Third Floor, Two North Market Street, San Jose, CA, 95113, US

(21) Appl. No.: 10/763,623

(22) Filed: Jan. 23, 2004

Related U.S. Application Data
(60) Provisional application No. 60/484,981, filed on Jul. 3, 2003.

(51) Int. Cl. H04N 5/76; H04N 5/781

(52) U.S. Cl. 386/94; 386/125

(57) ABSTRACT

Embodiments of the present invention are directed to a method and system for digitally recording broadcast content. In one embodiment, the broadcast content is received and a first digital copy of the broadcast content is stored (e.g., on a magnetic storage device). The first digital copy of the broadcast content is formatted to be displayed by a display device (e.g., encoded MPEG format). A second digital copy of the broadcast content is also made and stored on the magnetic storage device. The second digital copy of the broadcast content is formatted to be stored upon an optical media storage device. The second digital copy can be high-speed dubbed from the magnetic storage device to the optical media storage device.

### RELATED APPLICATIONS

The present application claims priority to U.S.P.T.O. provisional application No. 60/484,981 filed Jul. 3, 2003 entitled Personal Video Recording System for Digital Broadcasting Contents by Henry Derovanessian, Hajime Inoue, Hiroshi Yasunishi, and Yoshiaki Matsumura, attorney docket number 50T5626.PRO, assigned to the assignee of the present invention, and which is hereby incorporated by reference in its entirety herein.

### FIELD OF THE INVENTION

The present invention relates to the field of digital recording. More specifically, embodiments of the present invention are directed to a method and system for digitally recording broadcast content.

### BACKGROUND OF THE INVENTION

A digital set-top box is a device that enables a television to become a user interface to the Internet and also enables a television to receive and decode digital television (DTV) broadcasts. A digital set-top box may also be used by television viewers who wish to use their current analog television sets to receive digital broadcasts.

A typical digital set-top box contains one or more digital processors for running its operating system and for parsing the MPEG transport stream of a digital broadcast. A digital set-top box may also include RAM, an MPEG decoder chip, and additional chips for audio decoding and processing. More sophisticated digital set-top boxes may also contain a hard drive for storing recorded television broadcasts, for downloaded software, and for other applications provided by a DTV service provider. Some digital set-top boxes may also include a writeable digital versatile disk drive (e.g., a DVD R/W drive) to facilitate creating copies of broadcast content.

Generally, a digital broadcast is formatted in transport stream format that is compatible for displaying the content on a television. However, most DVD R/W drives require a data stream format to store data on a DVD disk. Therefore, a format conversion process occurs before broadcast content formatted for television viewing can be copied onto a DVD R/W disk.

FIG. 1 is a block diagram of an exemplary prior art system 100 for storing broadcast content. In FIG. 1, analog and/or digital broadcast content is sent via hard disk drive interface 101 to hard disk drive 102 for storage. Typically, the broadcast content is stored upon hard disk drive 102 before the format conversion occurs. The broadcast content is now formatted to be displayed on a user's television (e.g., a transport stream format). However, DVD's utilize a data stream format. Therefore, the broadcast content must be converted to a data stream format by format conversion module 103 before the broadcast content can be copied to DVD. In the embodiment of FIG. 1, format conversion module 103 performs a format conversion of the broadcast content comprising an MPEG decode process 105 in which the broadcast content is converted from a transport stream format to an analog/REC 656 signal. The analog signal then undergoes an MPEG encode process 106 in which it is converted to a data stream format. After format conversion processing has completed, the broadcast content, in data stream format, is sent to a DVD R/W drive 104 where a copy of the broadcast content can be made which is capable of being played back using a DVD player.

Typically, the hard disk drive on which the broadcast content is stored has a limited capacity. Therefore users often copy programming to DVD for long term storage. However, the format conversion process is limited to performing “real-time” format conversion of the data stream because the digital broadcast is converted to an analog/REC 656 signal. In other words, the data stream passes through format conversion module 103 at the same rate at which it is received by system 100. For example, performing a format conversion of a two hour program takes the user has to wait 2 hours for the conversion process to be completed. As a result, high speed dubbing is not supported by current systems such as those used in FIG. 1. This is inconvenient for many users who may want to quickly copy the broadcast content to disk to free space on the hard disk drive for additional programming.

Another problem with the format conversion process is that, due to the numerous conversion steps performed by format conversion module 103, errors can be introduced into the data or resolution can be lost both of which degrade the picture and/or sound quality of the broadcast content. Referring again to FIG. 1, errors in the data stream may be introduced in format conversion module 103 when the broadcast content, in transport stream format, is first converted to an analog/REC656 signal. Additionally, errors in the data stream may be introduced when the analog/REC656 signal is converted to a data stream format.

### SUMMARY OF THE INVENTION

Accordingly, a need exists for a method and system for facilitating high-speed dubbing of broadcast content to a media storage device such as a digital versatile disk (DVD). While meeting the above stated need, it is also desirable to provide such a system an method that allows high picture quality by minimizing data stream errors and loss of resolution when converting to a format compatible with a DVD.

Embodiments of the present invention provide a method and system for facilitating high-speed dubbing of broadcast content to a media storage device such as a digital versatile disk (DVD). Furthermore, embodiments of the present invention reduce data stream resolution loss when converting to a format compatible with a DVD.

In one embodiment, the broadcast content is received and a first digital copy of the broadcast content is stored. The first copy of the broadcast content is formatted to be displayed by a display device (e.g., formatted as encoded MPEG data). A second copy of the broadcast content is also stored. The second copy of the broadcast content is formatted to be stored upon a media storage device (e.g., an optical recording medium).

The following is an exemplary embodiment of the present invention for digitally recording broadcast content. The broadcast content is received and stored on a hard disk drive (e.g., at a set-top box device). In embodiments of the present invention, the broadcast content may be an analog or digital (e.g., standard definition or high definition) broadcast. In embodiments of the present invention, as the broadcast content is received, it is converted in real-time to a format compatible with a DVD R/WA disk and stored as a second digital copy on the hard disk in an encoded DVD R/W format.

When a user wishes to copy the broadcast content to a media storage device such as a DVD R/W, the second digital copy is accessed and used to create a copy of the broadcast content on the DVD R/W disk. Because the format conversion has already been performed, high-speed dubbing of the broadcast content is supported. Additionally, in embodiments of the present invention, fewer operations are performed to covert the broadcast content to a format compatible with a DVD R/W disk. Therefore, fewer data errors are introduced into the data stream during the format conversion process.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 is a block diagram of an exemplary prior art system for storing broadcast content.

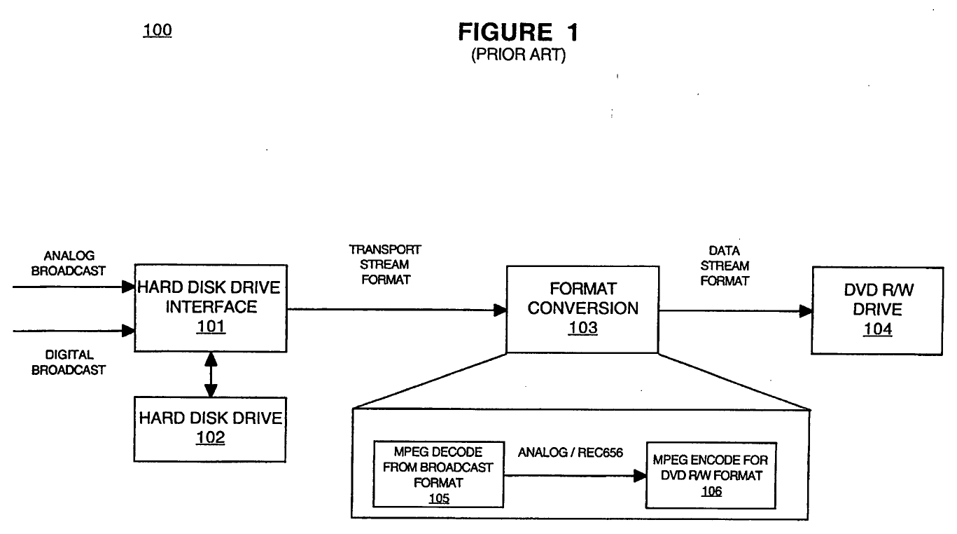

FIG. 2 is a block diagram of an exemplary system for digitally recording broadcast content in accordance with embodiments of the present invention.

FIG. 3 is a block diagram, showing in greater detail, components of an exemplary system for digitally recording broadcast content in accordance with embodiments of the present invention.

FIG. 4 is a flowchart of a method for digitally recording broadcast content in accordance with embodiments of the present invention.

FIG. 5 is a flowchart of a method for performing high-speed dubbing of broadcast content in accordance with embodiments of the present invention.

### DETAILED DESCRIPTION OF EMBODIMENTS OF THE PRESENT INVENTION

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

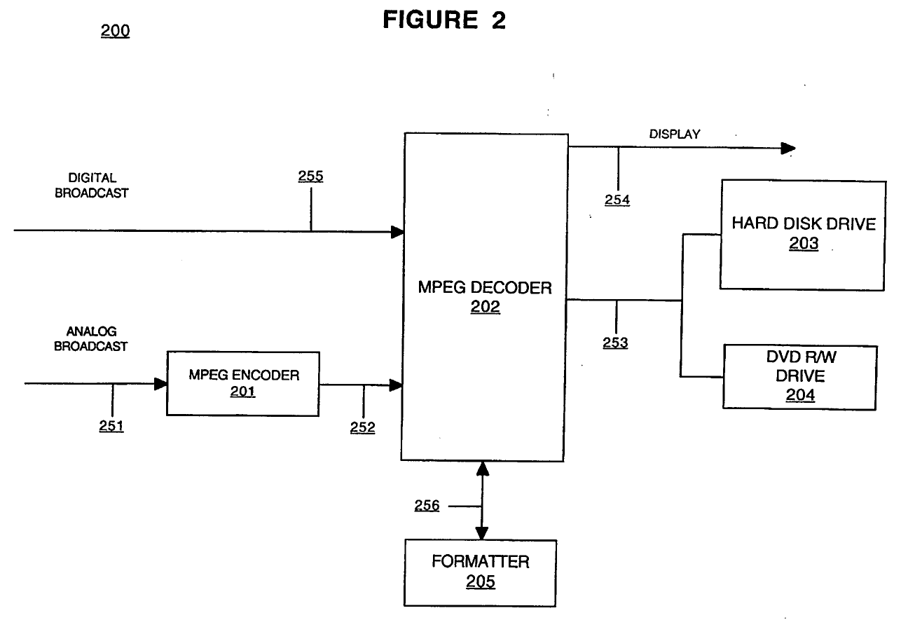

FIG. 2 is a block diagram of an exemplary system 200 for digitally recording broadcast content in accordance with embodiments of the present invention. In embodiments of the present invention, system 200 may be implemented as a set-top box or any electronic unit. In FIG. 2, analog broadcast content is received via coupling 251 into MPEG encoder 201. MPEG encoder 201 converts the analog signal of the broadcast content into a digital format in which the data is packetized and sent to MPEG decoder 202 via coupling 252. In one embodiment, MPEG decoder 202 passes through the digital packets in encoded format to hard disk drive 203 via coupling 253 where a first digital copy of the broadcast content is stored. While the present embodiment recites storing the first digital copy of the broadcast content on a hard disk drive, embodiments of the present invention are well suited for storing the first digital copy of the broadcast content upon a variety of storage media. For example, the first digital copy can be stored in a networked storage medium such as a storage area network (SAN).

Embodiments of the present invention use hard drive 203 as temporary storage during real-time viewing to support digital video recorder features such as pause, cue, rewind, etc. For example, to pause the recorder, hard drive 203 continuously spools the data until playback of the content is resumed. Additionally, storing the first digital copy of the broadcast content on hard disk drive 203 allows a user to view the broadcast content at a later time that is more convenient to the user.

In embodiments of the present invention, when the broadcast content is viewed, it is sent from hard disk drive 203 to MPEG decoder 202 wherein the digitally encoded broadcast content is decoded and sent via coupling 254 to a display device (e.g., a television). Again, this may be performed in a real-time operation which is substantially concurrent with the receiving of the broadcast content, or may occur at a later time.

In embodiments of the present invention, the broadcast content may also sent be from MPEG decoder 202 to formatter 205 via coupling 256 wherein the broadcast content is converted into a format compatible with a second storage medium. For example, in one embodiment, the broadcast content is converted into a data stream format which facilitates storing the broadcast content on a recordable DVD R/W disk. Again, while the present embodiment recites a recordable DVD R/W disk, embodiments of the present invention are well suited for converting the broadcast content into a variety of formats. Additionally, formatter 205 may convert the broadcast content into more than one format to be compatible with a variety of storage media. In embodiments of the present invention, the broadcast content is converted by formatter 205 concurrent with its being displayed by a display device. In embodiments of the present invention, this may occur in real-time as the broadcast content is received by system 200 (e.g., via coupling 251). Alternatively, the broadcast content may be stored on hard disk drive 203 as the first digital copy and undergo the format conversion by formatter 205 at a later time. In embodiments of the present invention, this is controlled by the user of system 200. For example, a user may first wish to review the broadcast content before deciding whether to create the second digital copy, and thus use more storage space of hard disk drive 203.

After the broadcast content is converted, it is passed through MPEG decoder 202 via coupling 256 and can be sent to hard disk drive 203 where a second digital copy of the broadcast content is stored in the converted format. In embodiments of the present invention, the second digital copy is formatted to be compatible with a media storage device (e.g., a recordable DVD R/W device). In embodiments of the present invention, the broadcast content may also be sent to DVD R/W drive 204 concurrent with creating the second digital copy on hard disk drive 203 to enable writing the broadcast content to a DVD R/W disk.

Storing a copy of the broadcast content that is already formatted to be compatible with a second storage medium is advantageous over previous systems because high speed dubbing of the broadcast content can be supported. In prior implementation, the process of format conversion was performed in real-time. Thus, if the broadcast content was a two hour program, the format conversion process also took two hours; namely, it required this much time to dub the program. This has proved to be inconvenient to many users who want to quickly copy the broadcast content onto, for example, a DVD R/W disk. For example, if a user watches a two hour program then decides to copy the program, the user would have to wait an additional two hours for the copy to be created.

However, according to embodiments of the present invention, a copy of the broadcast content can be created which is already formatted for use by the DVD R/W drive. This allows a user to select a high-speed dubbing mode which greatly reduces the amount of time needed to copy the broadcast content to a DVD R/W disk. For example, in embodiments of the present invention, if the broadcast content was a two hour program, a user can copy the content to a DVD R/W disk in 5-10 minutes depending on the performance of the system used.

Additionally, system 200 can also receive digital broadcast content via coupling 255 and MPEG decoder 202. In embodiments of the present invention, the digital broadcast content may comprise a standard definition (SD) digital broadcast or a high definition (HD) digital broadcast. Typically, digital broadcast content is received as a packetized data stream. The packetized data is passed through MPEG decoder 202 to hard disk drive 203 via coupling 253 wherein a first digital copy of the broadcast content is stored to support features of the digital video recorder as described above. The broadcast digital data is stored in an encoded MPEG format. When the broadcast content is accessed for playback, it is sent from hard disk drive 203 to MPEG decoder 202 via coupling 253 wherein it is decoded and sent to the display device via coupling 254.

As described above, in embodiments of the present invention, the broadcast content may also sent to MPEG decoder 202 for decoding and then to formatter 205 via coupling 256 wherein the broadcast content is converted into a format compatible with a second storage medium (e.g., a data stream format). In embodiments of the present invention, the broadcast content is converted by formatter 205 in real-time (e.g., concurrent with its being displayed), or may be stored on hard disk drive 203 and undergo the format conversion by formatter 205 at a later time. The broadcast content undergoes format conversion and is sent through MPEG decoder 202 via coupling 256 and then to hard disk drive 203 wherein a second digital copy of the broadcast content is stored.

Again, storing a copy of the broadcast content that is already formatted to be compatible with a media storage device is advantageous over previous systems because high speed dubbing of the broadcast content can be supported. Additionally, in embodiments of the present invention, when the broadcast content comprises a digital broadcast, there is no fidelity loss associated with converting the broadcast content to a format compatible with a DVD R/W device. In prior implementations, the broadcast content, including digital broadcast content, was first converted into an analog signal, and then underwent an MPEG encoding into a data stream format compatible with DVD R/W devices. As a result, errors can be introduced into the data which degrade sound and picture quality. However, in embodiments of the present invention, an interim conversion is not required when performing format conversion. As a result, greater fidelity to the original broadcast content is realized.

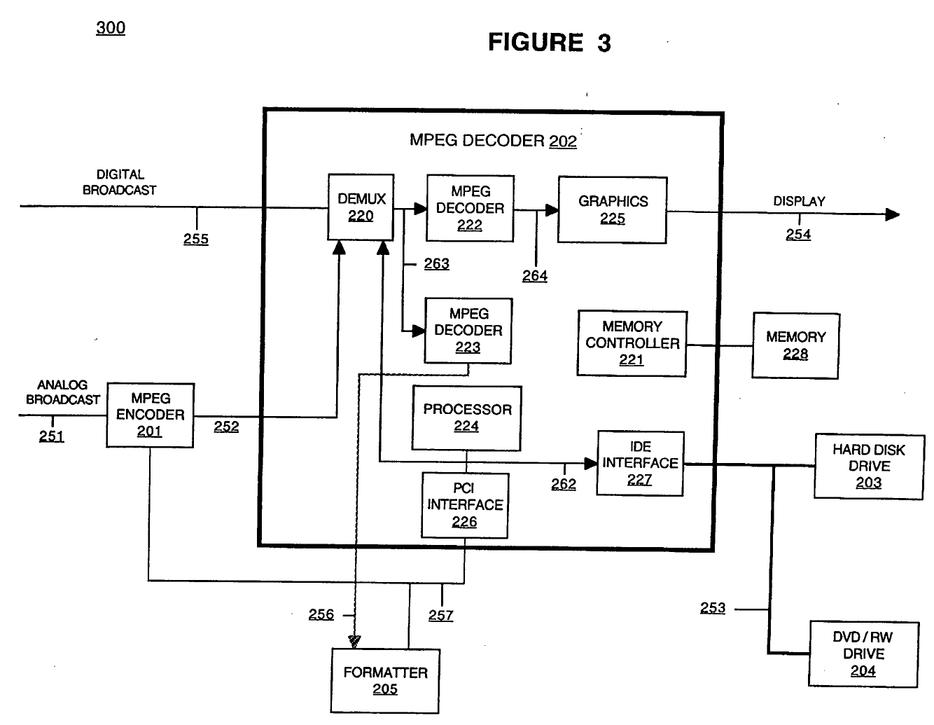

FIG. 3 is a block diagram, showing in greater detail, components of exemplary system 200 for digitally recording broadcast content in accordance with embodiments of the present invention. In embodiments of the present invention, system 200 may receive broadcast content that is sent via cable, terrestrial (e.g., radio broadcast), or satellite networks. In the embodiment of FIG. 3, analog broadcast content is received via coupling 251, digitized and encoded to a digital format by MPEG encoder 201 and sent to MPEG decoder 202 via coupling 252. Processor 224 of MPEG decoder 202 controls demux 220 to send recording data to memory 228 via memory controller 221. For clarity, the connections between memory controller 221 and other components of MPEG decoder 202 have been omitted. Processor 224 also controls memory controller to send the packetized data to an IDE interface 227 via bus 262. The packetized data is then sent via coupling 253 to hard disk drive 203 wherein a first digital copy of the encoded MPEG data is stored. If the broadcast content comprises digital broadcast content, it is sent to hard disk drive 203 wherein a first digital copy of the broadcast content is stored. In embodiments of the present invention, the first digital copy of the broadcast content may be formatted in a high definition or standard definition format.

In one embodiment, when the broadcast content is accessed for playback, it is retrieved from hard disk drive 203 and sent via IDE interface 227 to memory 228 via memory controller 221 and then sent to MPEG decoder 222. In embodiments of the present invention, DVR/PVR controller software processed by processor 224 typically comprises logic for controlling the presentation of the broadcast content by controlling demux 220. For example, a DVR/PVR software controller comprises logic for controlling functions such as playback, pause, cue, rewind, slow-motion play, etc. A PVR/DVR software controller comprises logic for performing the functions of a DVR controller and additional features such as tracking program preferences, recommending programs, etc. In the embodiment of FIG. 3, the broadcast content is decoded by MPEG decoder 222 and sent via coupling 264 to a graphics component 225 and then to the display device via coupling 254. In embodiments of the present invention, this process can be performed in real-time, that is, substantially concurrent to receiving the broadcast content. Alternatively, the broadcast content can be stored on hard disk drive 203 and accessed for playback at a later time.

In embodiments of the present invention, demux 220 sends the broadcast content to MPEG decoder 223 wherein the broadcast content may be formatted into an interim signal. For example, if the digital broadcast content comprises a high definition digital broadcast, it cannot be stored by a DVD R/W. Therefore, MPEG decoder 223 would first “down decode” the HD broadcast content into a standard definition digital format. In one embodiment, the interim signal from MPEG decoder 223 comprises an analog signal. The interim signal is sent from MPEG decoder 223 to formatter 205 via coupling 256.

As described above with reference to FIG. 2, formatter 205 converts the broadcast content into a format (e.g., a data stream format) that is compatible with a media storage device such as a DVD R/W device. The broadcast content is then sent via coupling 257 to PCI interface 226 and then to IDE interface 227. In embodiments of the present invention, a second digital copy of the broadcast content is then stored using hard disk drive 203. The second digital copy is formatted to be compatible with a media storage device. In embodiments of the present invention, the broadcast content, in the data stream format, may also be sent to DVD R/W drive 204 substantially concurrent with creating the second digital copy on hard disk drive 203, or may be accessed at a later time.

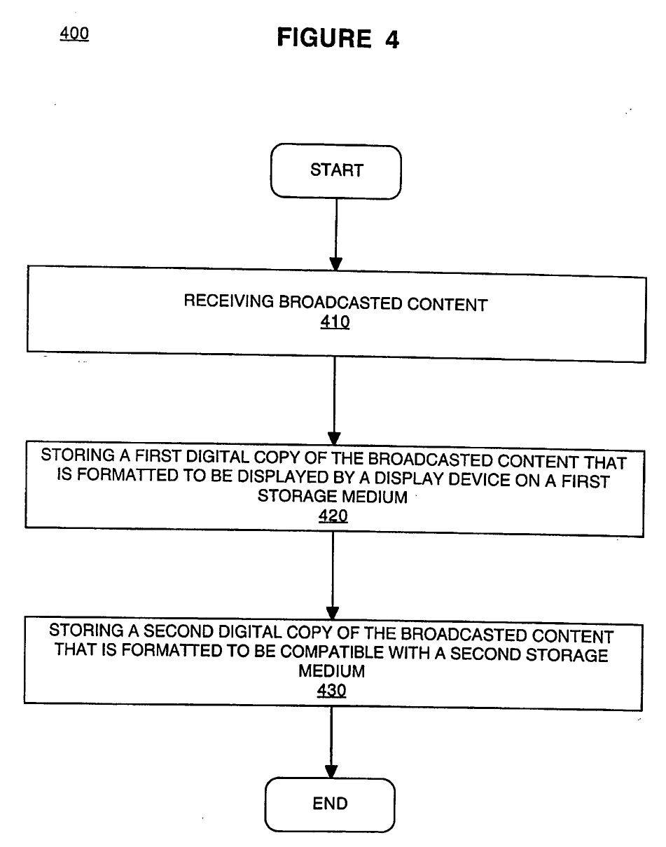

FIG. 4 is a flowchart of a method for digitally recording broadcast content in accordance with embodiments of the present invention. In step 410 of FIG. 4, broadcast content is received. As discussed above with reference to FIG. 2, analog broadcast content is received via coupling 251, digitally encoded by MPEG encoder 201, and sent via coupling 252 to MPEG decoder 202. Similarly, digital broadcast content is received via coupling 255 by MPEG decoder 202. In embodiments of the present invention, the digital broadcast content may be in a standard definition format or a high definition format.

In step 420 of FIG. 4, a first digital copy of the broadcast content that is formatted to be displayed by a display device is stored on a first storage medium. As discussed above with reference to FIG. 2, embodiments of the present invention store received the broadcast content on hard disk drive 203. For example, the analog broadcast content is now digitally encoded and is stored on hard disk drive 203 Similarly, the digital broadcast content is stored on hard disk drive 203 in the format in which it was received (e.g., standard or high definition format) in embodiments of the present invention.

In step 430 of FIG. 4, a second digital copy of the broadcast content that is formatted to be compatible with a second storage medium is stored. In embodiments of the present invention, the broadcast content is converted to a format compatible with a recordable DVD R/W disk and stored as a second digital copy on hard disk drive 203. In embodiments of the present invention, this format conversion may be performed in real-time as the content is received. Alternatively, the format conversion process may occur at a later time and is performed by accessing the first digital copy stored on hard disk drive 203.

Advantageously, by performing the format conversion and storing a second digital copy of the broadcast content, a user can copy the broadcast content to a DVD R/W disk in a high-speed dubbing mode (e.g., directly from hard disk drive 203 to the DVD R/W drive 204). Additionally, in embodiments of the present invention, a standard definition digital broadcast can be converted directly to a data stream format without requiring an interim format such as an analog/REC656 signal. As a result, fewer data errors and fidelity losses are introduced when converting the format of the broadcast content.

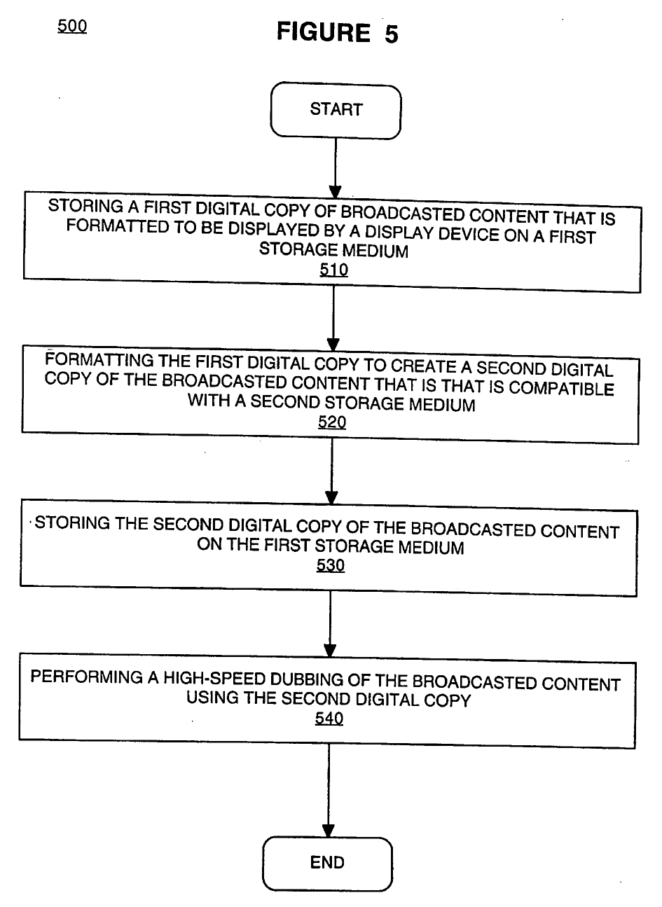

FIG. 5 is a flowchart of a method 500 for performing high-speed dubbing of broadcast content in accordance with embodiments of the present invention. In step 510 of FIG. 5, a first digital copy of broadcast content that is formatted to be displayed by a display device is stored on a first storage medium. As discussed above with reference to FIG. 2, analog broadcast content and/or digital broadcast content is digitally stored on hard disk drive 203 in an encoded MPEG format.

In step 520 of FIG. 5, the first digital copy is decoded and then formatted to create a second digital copy of the broadcast content that is compatible with a second storage medium. As discussed above with reference to FIG. 2, the first digital copy is accessed from hard disk drive 203, decoded, and sent to formatter 205 for format conversion. In embodiments of the present invention, formatter 205 converts the data from a transport stream format to a data stream format that is compatible with a recordable DVD R/W disk.

In step 530 of FIG. 5, the second digital copy of the broadcast content is stored on the first storage medium. After the format conversion process is completed, a second copy of the broadcast content, in data stream format, is stored on hard disk drive 203.

In step 540 of FIG. 5, a high-speed dubbing operation of the broadcast content is performed using the second digital copy. Using embodiments of the present invention, a copy of the broadcast content can be created in which the data from the second digital copy stored on hard disk drive 203 can be copied at a high bit-rate to a DVD R/W disk disposed on DVD R/W drive 204.

The preferred embodiment of the present invention, a method and system for digitally recording broadcast content, is thus described. While the present invention has been described in particular embodiments, it should be appreciated that the present invention should not be construed as limited by such embodiments, but rather construed according to the following claims.

What is claimed is:

1. A method for digitally recording broadcast content comprising:
receiving said broadcast content;
storing a first digital copy of said broadcast content on a first storage medium, wherein said first digital copy is formatted to be displayed by a display device through a decoder; and
storing a second digital copy of said broadcast content on said first storage medium, wherein said second digital copy is formatted to be compatible with a second storage medium.

2. The method as recited in claim 1 wherein said first storage medium comprises a hard disk drive unit and said second storage medium comprises a recordable digital versatile disk (DVD).

3. The method as recited in claim 1 further comprising:
selectively creating said second digital copy, wherein said second digital copy is created in real-time.

4. The method as recited in claim 1 further comprising:
selectively creating said second digital copy, wherein said second digital copy is created after said first digital copy is created.

5. The method as recited in claim 1 wherein said broadcast content comprises an analog signal.

6. The method as recited in claim 5 wherein said receiving further comprises:
performing a first formatting operation, wherein said broadcast content is converted to a digital format; and
performing a second formatting operation, wherein said broadcast content is formatted to be compatible with said second storage medium.

7. The method as recited in claim 1 wherein said broadcast content comprises a high-definition digital broadcast.

8. The method as recited in claim 7 wherein said receiving further comprises:
storing said high-definition digital broadcast as said first digital copy on said first storage medium;
converting said high-definition digital broadcast to an interim signal; and
performing a formatting operation, wherein said interim signal is formatted to be compatible with said second storage medium to create said second digital copy.

9. The method as recited in claim 1 wherein said broadcast content comprises a standard-definition digital broadcast.

10. The method as recited in claim 9 wherein said receiving further comprises:
storing said standard-definition digital broadcast as said first digital copy; and
performing a formatting operation, wherein said broadcast content is formatted to be compatible said second storage medium to create said second digital copy.

11. The method as recited in claim 1 further comprising performing a high-speed dubbing operation wherein a copy of said second digital copy is stored on said second storage medium.

12. A system for digitally recording broadcast content comprising:
a signal input for receiving said broadcast content;
a first storage medium coupled with said signal input and for storing a first digital copy of said broadcast content, wherein said first digital copy is formatted to be displayed by a display device through a decoder; and
a formatter coupled with said magnetic storage device for creating a second digital copy of said broadcast content that is formatted to be compatible with a second storage medium, wherein said second digital copy is also stored by said first storage medium.

13. The system of claim 12 wherein said first storage medium comprises a hard disk drive and said second storage medium comprises a recordable digital versatile disk (DVD).

14. The system of claim 12 wherein said system is selectively controlled to create said second digital copy in real-time.

15. The system of claim 12 wherein said system is selectively controlled to create said second digital copy after said first digital copy is created.

16. The system of claim 12 wherein said signal input comprises an analog signal input, said system further comprising:
an encoder coupled with said analog signal input and with said first storage medium, said encoder for digitally encoding an analog signal comprising said broadcast content; and
wherein said formatter is further for converting said broadcast content into a format suitable to be displayed by said display device.

17. The system of claim 12 wherein said signal input comprises a digital signal input.

18. The system of claim 17 wherein said broadcast content comprises a standard-definition digital broadcast.

19. The system of claim 17 wherein said broadcast content comprises a high-definition digital broadcast, said system further comprising:
a decoder coupled with said digital signal input and with said formatter, said decoder for converting said high-definition digital broadcast into an interim signal comprising said broadcast content and wherein said formatter converts said interim signal into a format compatible with said second storage medium.

20. A method for performing high-speed dubbing of broadcast content comprising:
storing on a first storage medium a first digital copy of said broadcast content that is encoded and formatted for display on a display device,
formatting said first digital copy to create a second digital copy of said broadcast content that is compatible with a second storage medium;
storing on said first storage medium said second digital copy of said broadcast content; and
performing a high-speed dubbing, wherein a copy of said second digital copy is stored on said second storage medium.

21. The method as recited in claim 20 wherein said broadcast content comprises an analog signal, said method further comprising:
digitally encoding said analog signal;
performing an initial formatting operation, wherein said broadcast content is encoded and formatted to be displayed by said display device and stored as said first digital copy; and
performing said formatting of said first digital copy, wherein said broadcast content is formatted to be stored upon said second storage medium.

22. The method as recited in claim 20 wherein said broadcast content comprises a high-definition digital broadcast, said method further comprising:
storing said high-definition digital broadcast as said first digital copy;
converting said first digital copy to an interim signal; and
performing said formatting of said first digital copy, wherein said interim signal is formatted to be compatible with said second storage medium.

23. The method as recited in claim 20 wherein said broadcast content comprises a standard-definition digital broadcast, said method further comprising:
storing said standard-definition digital broadcast as said first digital copy.

24. The method as recited in claim 20 wherein said first storage medium comprises a hard disk drive and said second storage medium comprises a recordable digital versatile disk (DVD).

25. The method as recited in claim 20 further comprising:
selectively creating said second digital copy, wherein said second digital copy is created in real-time.

26. The method as recited in claim 20 further comprising:
selectively creating said second digital copy, wherein said second digital copy is created after said first digital copy is created.
